(19) United States
(12) Patent Application Publication
(10) Pub. No.: US 2024/0110007 A1
(43) Pub. Date: Apr. 4, 2024

(54) PREPARATION OF POLY(CROWN ETHER)S

(71) Applicant: Saudi Arabian Oil Company, Dhahran (SA)

(72) Inventors: Hasmukh A. Patel, Katy, TX (US); Ahmet Atilgan, Houston, TX (US)

(21) Appl. No.: 17/944,342

(22) Filed: Sep. 14, 2022

(51) Int. Cl. C08G 65/16

(52) U.S. Cl. CPC C08G 65/16

(57) ABSTRACT

The present disclosure relates to methods for preparing a poly(crown ether). The present disclosure also relates to poly(crown ether)s prepared according to such methods.

### TECHNICAL FIELD

The present disclosure relates to methods of preparing a poly(crown ether). The present disclosure also relates to poly(crown ether)s prepared by such methods.

### BACKGROUND

Poly (crown ether)s are polymeric chains including crown ether macrocycles, that is, macrocyclic oligomers of alkylene oxide (e.g., ethylene oxide or propylene oxide) containing at least 3 oxygen atoms. The oxygen atoms in crown ether macrocycles are well situated to coordinate with cations located in the interior of the macrocyclic ethers, whereas the exterior of the macrocycles is hydrophobic, which can render the complexed cation soluble in organic solvents.

Crown ether moieties are typically represented as ‘[m]crown-n’ where ‘m’ represents the total number of atoms present in the macrocycle and ‘n’ represents the number of oxygen atoms present in the macrocycle. The binding selectivity of crown ethers for metal ions depends on the size of the interior of the ring. For example, [18]crown-6 has a high affinity for K⁺, [15]crown-5 for Na⁺, and [12]crown-4 for Li⁺.

Although crown ethers have been known for their exceptional host-guest affinity, their use has been limited, in part because conventional methods for preparing poly(crown ether)s involve multi-step syntheses. Typically, poly(crown ether)s are prepared by first synthesizing monomeric macrocyclic ethers, then functionalizing the monomers, and finally, polymerizing the functionalized monomers to form a crown ether-containing polymeric architecture. These synthetic routes necessarily involve different linkages, such as imide, amide, ester, urethane, azo, etc., within the polymeric network. Such linkages may undesirably affect the chemical and/or physical properties of the polymer. For example, polymers including such linkages may be difficult to process, and/or maybe unsuitable for certain applications, such as those involving harsh conditions (e.g., sour gas processing).

Accordingly, there is a need for synthetic routes to poly(crown ether)s that are more direct than conventional methods. There is also a need for synthetic routes to poly(crown ether)s that can avoid the linking groups required by conventional methods.

### SUMMARY

Provided in the present disclosure is a method including:
contacting a compound of Formula (I):

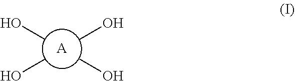

with a compound of Formula (II):

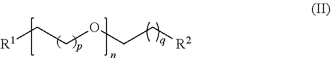

in the presence of a base;
   wherein:
A is C₆-C₄₀ aryl or C₄C₃₈ , each optionally substituted with 1-8 R^{a};
each R^{a} is independently selected from oxo, cyano, C₆-C₁₄ aryl, C₁-C₄ alkyl, and C₁-C₄ alkoxy;
R¹ and R² are each independently halo;
p and q are each independently 1-4; and n is 0-8.

In some embodiments, each —OH is attached to a carbon ring member of an all-carbon aromatic ring. In some embodiments, each carbon ring member attached to an —OH is further attached to one other carbon ring member attached to an —OH.

In some embodiments, A is C₆-C₂₀ aryl. In some embodiments, A is C₆-C₁₄ aryl optionally substituted with 1-6 R^{a}, and each R^{a} is independently C₆-C₁₄ aryl. In some embodiments, A is C₁₀-C₄₀ aryl.

In some embodiments, A includes a multiple-condensed ring system. In some embodiments, A includes an all-carbon multiple-condensed ring system. In some embodiments, the multiple-condensed ring system includes two or more spiro-linked rings. In some embodiments, the multiple-condensed ring system includes two or more bridged rings. In some embodiments, the multiple-condensed ring system is substituted with 1-4 R^{a} , and each R^{a} is independently selected from oxo, C₆-C₁₄ aryl, and C₁-C₄ alkyl.

In some embodiments, the multiple-condensed ring system includes one or more rings derived from fluorene, indane, indene, chromane, naphthalene, or any combination thereof. In some embodiments, the multiple-condensed ring system includes two or more spiro-linked rings derived from fluorene, indane, indene, or any combination thereof. In some embodiments, the compound of Formula (I) is:

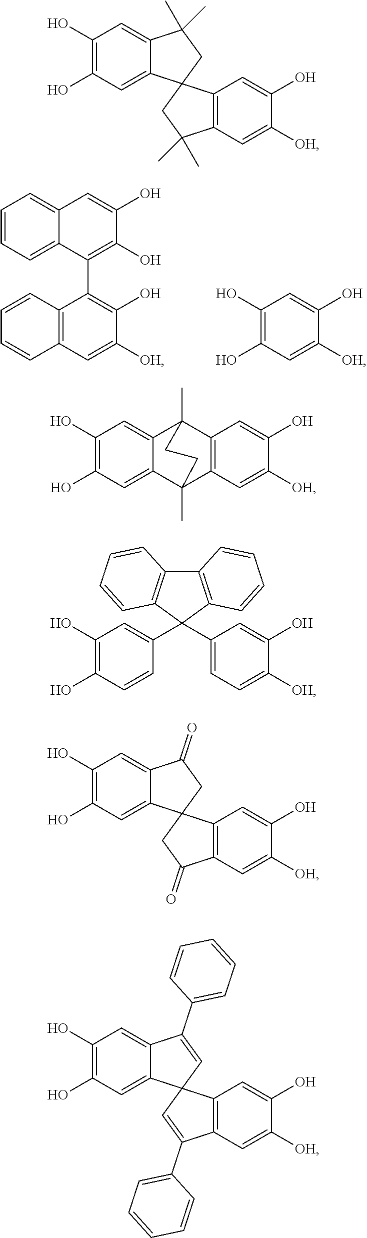

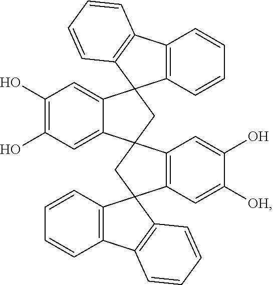 [SMILES: Oc1cc2c(cc1O)C1(CC23CC2(c4ccccc4-c4ccccc42)c2cc(O)c(O)cc23)c2ccccc2-c2ccccc21]

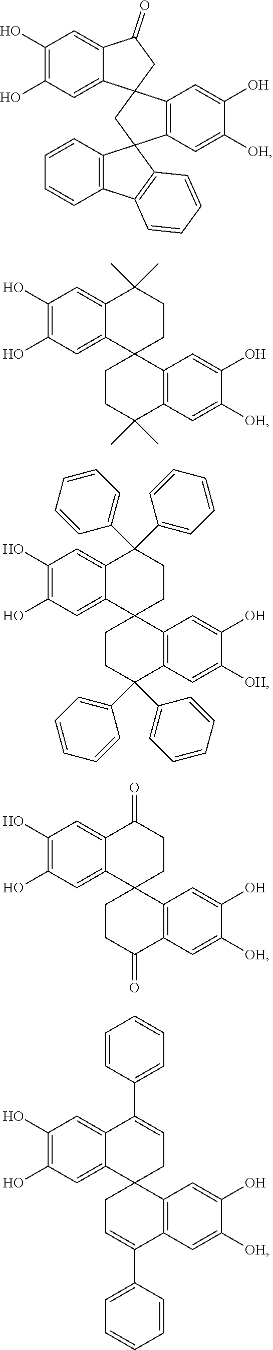

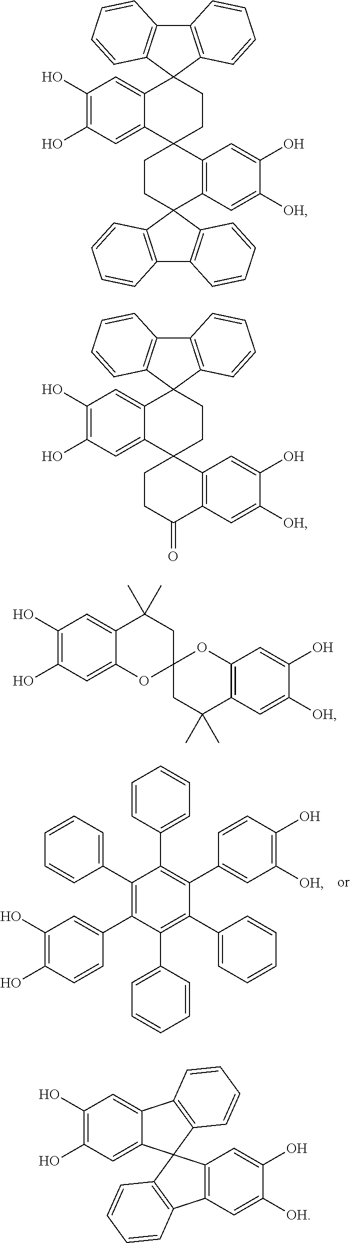

In some embodiments, p and q are each 1. In some embodiments, p and q are each 2. In some embodiments, n is 0. In some embodiments, n is 1-4. In some embodiments, R¹ and R² are the same. In some embodiments, R¹ and R² are each independently —F or —Cl.

In some embodiments, the base includes an inorganic base, an organic base, or any combination thereof. In some embodiments, the inorganic base includes potassium carbonate, sodium carbonate, lithium carbonate, potassium hydroxide, sodium hydroxide, lithium hydroxide, or any combination thereof. In some embodiments, the organic base includes N,N-diisopropylethylamine, trimethylamine, or any combination thereof.

In some embodiments, the compound of Formula (I) and the compound of Formula (II) are contacted in a reaction mixture including the base and a solvent. In some embodiments, the solvent includes dimethylformamide, dimethyl sulfoxide, n-methyl pyrrolidone, diethylformamide, or any combination thereof. In some embodiments, the compound of Formula (I) and the compound of Formula (II) are each independently present in the reaction mixture in an amount of about 1 wt % to about 25 wt % of the reaction mixture.

In some embodiments, a molar ratio of the compound of Formula (I) and the compound of Formula (II) present in the reaction mixture is about 1:1.5 to about 1:2.5. In some embodiments, a molar ratio of the compound of Formula (I) and the base present in the reaction mixture is about 1:1 to about 1:10.

In some embodiments, a temperature of the reaction mixture is about 20° C. to about 140° C. In some embodiments, the method includes contacting the compound of Formula (I) and the compound of Formula (II) for about 1 hour to about 14 days.

Also provided is a poly(crown ether), prepared according to any method described in the present disclosure.

Also provided in the present disclosure is a poly(crown ether) including a structural repeat unit of Formula (III):

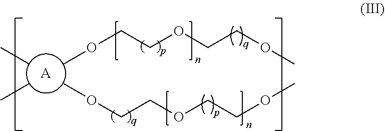

wherein:
A is C₆C₄₀ aryl or C₄C₃₈ heteroaryl, each optionally substituted with 1-8 R^{a};
each R^{a} is independently selected from oxo, cyano, C₆C₁₄ aryl, C₁C₄, and C₁C₄ alkoxy;
p and q are each independently 1-4; and
n is 0-8.

In some embodiments, A is any optionally substituted C₆C₄₀ aryl or optionally substituted C₄C₃₈ heteroaryl described in the present disclosure with respect to Formula (I). In some embodiments, each of n, p, and q of Formula (III) is any value described in the present disclosure with respect to Formula (II).

### BRIEF DESCRIPTION OF DRAWINGS

FIG. 1 is an ¹H NMR spectrum of a poly(crown ether) prepared according to certain embodiments of the present disclosure.

FIG. 2 is a set of Fourier transform infrared (FTIR) spectra of a poly(crown ether) prepared according to certain embodiments of the present disclosure, and the starting materials therefor.

FIG. 3 is a plot of thermogravimetric analysis (TGA) curves of a poly(crown ether) prepared according to certain embodiments of the present disclosure, and the starting materials therefor.

FIG. 4 is an ¹H NMR spectrum of a poly(crown ether) prepared according to certain embodiments of the present disclosure.

FIG. 5 is a set of Fourier transform infrared (FTIR) spectra of a poly(crown ether) prepared according to certain embodiments of the present disclosure, and the starting materials therefor.

FIG. 6 is a plot of thermogravimetric analysis (TGA) curves of a poly(crown ether) prepared according to certain embodiments of the present disclosure, and the starting materials therefor.

FIG. 7 is an image of a film formed from a poly(crown ether) prepared according to certain embodiments of the present disclosure.

### DETAILED DESCRIPTION

The present disclosure relates to methods for preparing a poly(crown ether). In some embodiments, the methods provide a direct synthetic route from monomers to a poly(crown ethers). In some embodiments, the methods provide poly(crown ether)s free from linking groups such as imide, amide, ester, urethane, and azo groups. For example, in certain embodiments, the methods provide poly(crown ethers)s including crown ether monomeric units linked only by covalent carbon-carbon bonds. The present disclosure also relates to poly(crown ether)s prepared according to such methods. In some embodiments, poly(crown ethers)s prepared according to the methods of the present disclosure are suitable for further processing, for example, into films.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### DEFINITIONS

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used in the present disclosure can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in the present disclosure, the terms “structural repeat unit” and “monomer unit,” used in reference to a polymer, are interchangeable and refer to any repeating subunit of a polymer. For example, a poly(crown ether) of the present disclosure can be referred to as including crown ether monomer units, even though the poly(crown ether) is not formed by polymerizing functionalized crown ether-containing monomers.

As used in the present disclosure, the terms “crown ether macrocycle” and “crown ether” are interchangeable and refer to a cyclic polyether group containing at least 3 oxygen atoms, where each oxygen atom is separated from the other oxygen atoms by at least 2 carbon atoms.

As used in the present disclosure, the term “poly(crown ether)” refers to a polymer including a structural repeat unit containing a crown ether macrocycle.

As used in the present disclosure, the term “oxo” refers to ═O.

As used in the present disclosure, the term “cyano” refers to —C≡N.

As used in the present disclosure, the term “halo” refers to —F, —Cl, —Br, or —I.

As used in the present disclosure, the term “CₙCₘ alkyl” refers to any linear or branched saturated hydrocarbon group having n to m carbons. Alkyl groups include, but are not limited to, methyl, ethyl, propyl such as propan-1-yl, propan-2-yl (iso-propyl), butyl such as butan-1-yl, butan-2-yl (sec-butyl), 2-methyl-propan-1-yl (iso-butyl), 2-methyl-propan-2-yl (t-butyl), pentyl, hexyl, octyl, dectyl, and the like.

As used in the present disclosure, the term “Cₙ-Cₘ alkoxy” refers to —O—(Cₙ-Cₘ alkyl). Exemplary alkoxy groups include, but are not limited to, methoxy, ethoxy, propoxy (for example, n-propoxy and isopropoxy), butoxy (for example, n-butoxy and tert-butoxy), and the like.

As used in the present disclosure, the term “CₙCₘ aryl” refers to a single, all-carbon aromatic ring or a multiple-condensed ring system including at least one all-carbon aromatic ring, having n to m ring-member carbons. One example of an aryl group including a single, all-carbon aromatic ring is a benzene group (C₆ aryl). Other examples of aryl groups include multiple-condensed ring systems (for example, including 2-10 rings) in which at least one ring is all-carbon and aromatic, and the other rings may each independently be aromatic or non-aromatic carbocycle or non-aromatic heterocycle. Heterocycles can each independently include, for example, 1-5, or 1-3 heteroatoms selected from oxygen, nitrogen, and sulfur. The rings of the multiple-condensed ring system can be connected to each other by fused, spiro, and bridged bonds. Exemplary aryl groups include, for example, those groups derived from acenaphthylene, anthracene, azulene, benzene, chrysene, naphthalene, fluoranthene, fluorene, indane, indene, chromane, perylene, phenalene, phenanthrene, pyrene, and the like, as well as combinations thereof (for example, spiro-linked rings derived from chromane groups, indane groups, fluorine groups, dihydronaphthalene groups, tetrahydronaphthalene groups, and combinations thereof). Non-limiting examples of aryl groups include, but are not limited to, phenyl, indenyl, naphthyl, 1,2,3,4-tetrahydronaphthyl, anthracenyl, 2,2′,3,3′-tetrahydro-1,1′-spirobi[indene], 9,10-dihydro-9,10-ethanoanthracene, and groups derived from 1,1′-spirobi[indene], 1,1′-spirobi[indene]-3,3′(2H,2′H)-dione, 2′H,2″H-trispiro[fluorene-9,1′-indene-3′,1″-indene-3″,9″′-fluorene], 2H,2′H -1,1′-spirobi[naphthalene], 2,2′,3,3′-tetrahydro-4H,4′H-1,1′-spirobi[naphthalene]-4,4′-dione, 3,3′,4,4′-tetrahydro-2H,2′H-1,1′-spirobi[naphthalene], 2,2′-spirobi[chromane], 2′H -dispiro[fluorene-9,1′-indene-3′,1″-inden]-3″(2″H)-one, 2′,2″,3′,3″-tetrahydro-4″H -dispiro[fluorene-9,1′-naphthalene-4′,1″-naphthalen]-4″-one, 9,9′-spirobi[fluorene], and the like. In some embodiments, Cₙ-Cₘ aryl is C₆-C₄₀ aryl. In some embodiments, Cₙ-Cₘ aryl is C₆-C₃₀ aryl, C₆C₂₀ aryl, C₆-C₁₄ aryl, C₆-C₁₀ aryl, C₁₀ -C₄₀ aryl, C₁₀-C₃₀ aryl, C₁₀-C₂₀ aryl, C₂₀-C₄₀ aryl, or C₂₀-C₃₀ aryl. In some embodiments, Cₙ-Cₘ aryl is C₆ aryl.

As used in the present disclosure, the term “Cₙ-Cₘ heteroaryl” refers to an aryl group, described above, in which one or more of the aromatic carbon atoms (and any associated hydrogen atoms) are independently replaced with the same or different heteroatom or heteroatomic group, having n to m ring-member carbons. Exemplary heteroaryl groups include, for example, those groups derived from acridine, benzoimidazole, benzothiophene, benzofuran, benzoxazole, benzothiazole, carbazole, carboline, cinnoline, furan, imidazole, imidazopyridine, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyridone, pyrimidine, pyrrole, pyrrolizine, quinazoline, quinoline, quinolizine, quinoxaline, tetrazole, thiadiazole, thiazole, thiophene, triazole, xanthene, and the like, as well as combinations thereof. In some embodiments, Cₙ-Cₘ heteroaryl is C₄-C₃₈ heteroaryl. In some embodiments, Cₙ-Cₘ heteroaryl is C₄-C₃₀ heteroaryl, C₄-C₂₀ heteroaryl, C₄-C₁₂ heteroaryl, C₄-C₁₀ heteroaryl, C₈-C₃₈ heteroaryl, C₈-C₃₀ heteroaryl, C₈-C₂₀ heteroaryl, C₁₆-C₃₈ heteroaryl, or C₁₆-C₃₀ heteroaryl.

The term “substituted” means that an atom or group of atoms formally replaces hydrogen as a “substituent” attached to another group. The term “substituted,” unless otherwise indicated, refers to any level of substitution (for example, mono-, di-, tri-, tetra-, or penta-substitution, where such substitution is permitted. The substituents are independently selected, and substitution may be at any chemically accessible position. Substitution at a given atom is limited by valency. Substitution at a given atom results in a chemically stable molecule. The phrase “optionally substituted” means unsubstituted or substituted. A single divalent substituent (for example, oxo) can replace two hydrogen atoms.

Where a variable of the present disclosure defines a group having more than one substituent (for example, group A of Formula (I)) and the Markush group definition for that variable lists, for example, “alkyl” or “aryl,” then it is understood that the “alkyl” or “aryl” represents a substituent having the necessary valency. For example, where group A of Formula (I) is “phenyl,” “phenyl” is understood to represent a tetravalent benzene group. In another example, where group A of Formula (I) is “phenyl” further substituted with two R^{a}, “phenyl” is understood to represent a hexavalent benzene group.

### Preparation Methods

Provided in the present disclosure are methods of preparing a poly(crown ether) that include contacting a compound of Formula (I):

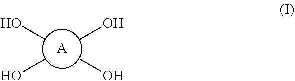

with a compound of Formula (II):

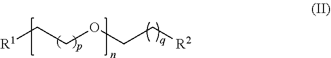

in the presence of a base;
wherein:
A is C₆-C₄₀ aryl or C₄-C₃₈ heteroaryl, each optionally substituted with 1-8 R^{a};
each R^{a} is independently selected from oxo, cyano, C₆-C₁₄ aryl, C₁-C₄ alkyl, and C₁-C₄ alkoxy;
R¹ and R² are each independently halo;
p and q are each independently 1-4; and
n is 0-8.

### Compounds of Formula (I)

The compounds of Formula (I) of the present disclosure include group A, substituted with four hydroxy groups. In some embodiments, A is otherwise unsubstituted C₆-C₄₀ aryl or C₄-C₃₈ heteroaryl, and each —OH substituent is independently attached to a carbon ring member of an all-carbon aromatic ring of the aryl or heteroaryl. In other embodiments, A is C₆-C₄₀ aryl or C₄-C₃₈ heteroaryl, each substituted with 1-8 R^{a}, and each —OH substituent is independently attached to a carbon ring member of an all-carbon aromatic ring of the aryl or heteroaryl, or to a carbon ring member of any all-carbon aromatic ring present in an R^{a} group. In some embodiments, each hydroxy-substituted carbon ring member is attached to one other hydroxy-substituted carbon ring member. In some embodiments, each hydroxy-substituted carbon ring member is present in the same all-carbon aromatic ring. In some embodiments, the hydroxy-substituted carbon ring members are each present in one of two different all-carbon aromatic rings.

In some embodiments, A includes a multiple-condensed ring system. In some embodiments, A includes an all-carbon multiple-condensed ring system. In some embodiments, the multiple-condensed ring system includes two or more spiro-linked rings, for example, two, three, or four spiro-linked rings. In some embodiments, the multiple-condensed ring system includes two or more bridged rings. In some embodiments, the multiple-condensed ring system includes one or more rings derived from fluorene, indane, indene, chromane, naphthalene, or any combination thereof. In some embodiments, the multiple-condensed ring system includes one or more spiro-linked rings derived from fluorene, indane, indene, or any combination thereof.

In some embodiments, A is C₆-C₃₀ aryl, C₆-C₂₀ aryl, C₆-C₁₄ aryl, C₆-C₁₀ aryl, C₁₀-C₄₀ aryl, C₁₀-C₃₀ aryl, C₁₀-C₂₀ aryl, C₂₀-C₄₀ aryl, or C₂₀-C₃₀ aryl. In some embodiments, A is C₆ aryl. In some embodiments, A is aryl not substituted with R^{a}. In some embodiments, A is aryl substituted with 1-8, 1-6, 1-4, 1-2, 2-8, 2-6, or 2-4 independently selected R^{a}. For example, in some embodiments, A is aryl substituted with 1, 2, 3, 4, 5, 6, 7, or 8 independently selected R^{a}.

In some embodiments, each R^{a} is independently selected from oxo, C₁-C₄ alkyl, and C₆-C₁₄ aryl. In some embodiments, one or more R^{a} is oxo, or each R^{a} is oxo. For example, in some embodiments, A is a 2,2′,3,3′-tetrahydro-1,1′-spirobi[indene] group substituted with two oxo. In some embodiments, one or more R^{a} is C₆-C₁₄ aryl, or each R^{a} is C₆-C₁₄ aryl. In some embodiments, one or more R^{a} is C₆-C₁₀ aryl, or each R^{a} is C₆-C₁₀ aryl. In some embodiments, one or more R^{a} is C₆ aryl, or each R^{a} is C₆ aryl. For example, in some embodiments, A is a 3,3′,4,4′-tetrahydro-2H,2′H-1,1′-spirobi[naphthalene] group substituted with four C₆ aryl. In another example, in some embodiments, A is a benzene group substituted with two, four, or six C₆ aryl. In some embodiments, one or more R^{a} is C₁₀ aryl, or each R^{a} is C₁₀ aryl. For example, in some embodiments, A is a naphthyl group substituted with one C₁₀ aryl, such as naphthyl. In some embodiments, one or more R^{a} is C₁-C₄ alkyl, or each R^{a} is C₁-C₄ alkyl. In some embodiments, one or more R^{a} is C₁ alkyl, or each R^{a} is C₁ alkyl. For example, in some embodiments, A is a 3,3′,4,4′-tetrahydro-2H,2′H-1,1′-spirobi[naphthalene] substituted with four C₁ alkyl. In some embodiments, the compound of Formula (I) is:

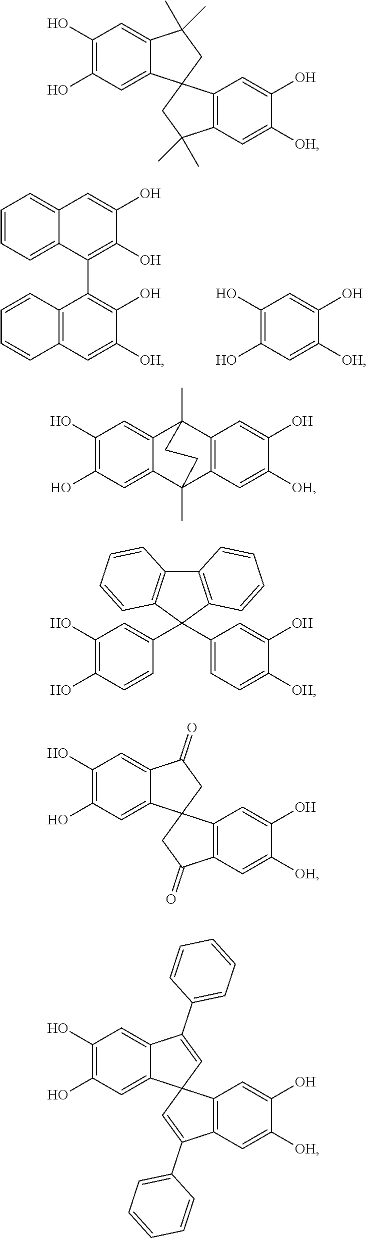

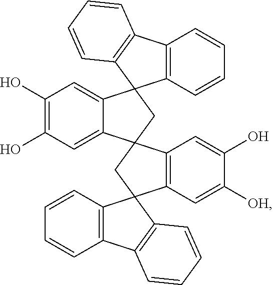 [SMILES: Oc1cc2c(cc1O)C1(CC23CC2(c4ccccc4-c4ccccc42)c2cc(O)c(O)cc23)c2ccccc2-c2ccccc21]

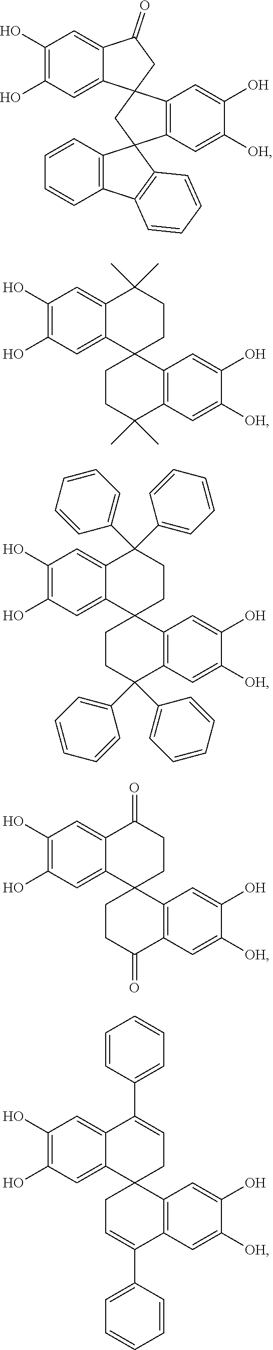

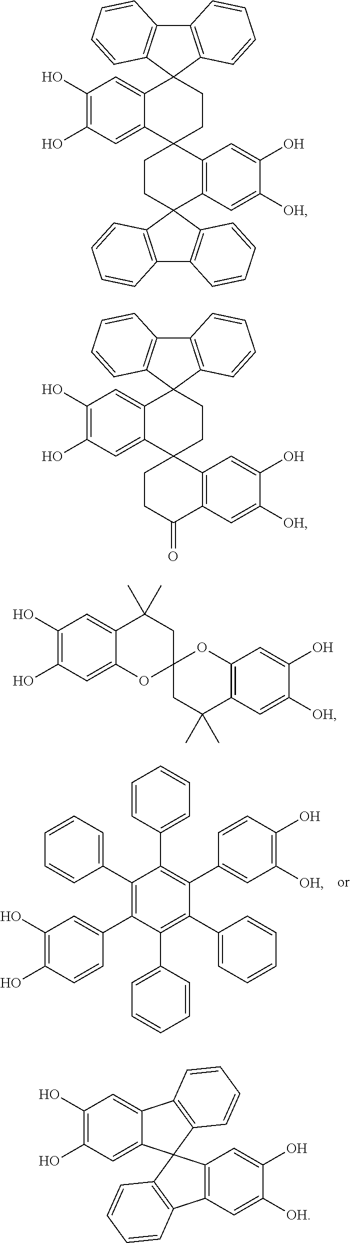

### Compounds of Formula (II)

As described above, a compound of Formula (I) of the present disclosure can be contacted with a compound of Formula (II):

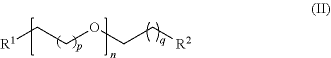

wherein p and q are each independently 1-4, and n is 0-8.

In some embodiments, p is 1, 2, 3, or 4. In some embodiments, p is 1 or 2. In some embodiments, q is 1, 2, 3, or 4. In some embodiments, q is 1 or 2. In some embodiments, p and q are each 1. In some embodiments, p and q are each 2. In some embodiments n is 0-6, 0-4, 1-8, 1-6, 1-4, 2-8, 2-6, or 2-4. In some embodiments, n is 0, 1, 2, 3, 4, 5, 6, 7, or 8. In some embodiments, n is 0, and q is 1 or 2. In some embodiments, n is 1-4, and p and q are each independently 1 or 2. In some embodiments, n is 1-4, and p and q are each 1.

In some embodiments, R¹ and R² are each independently —F, —Cl, or —Br. For example, in some embodiments R¹ and R² are each independently —F or —Cl. In some embodiments, R¹ and R² are the same. For example, in some embodiments, R¹ and R² are each —Cl.

### Base

As described above, the compound of Formula (I) and the compound of Formula (II) can be contacted in the presence of a base. The base can include any base suitable to catalyze a double aromatic nucleophilic substitution reaction between a compound of Formula (I) of the present disclosure and a compound of Formula (II) of the present disclosure. In some embodiments, the base includes an inorganic base, an organic base, or any combination thereof.

In some embodiments, the inorganic base includes a carbonate or a hydroxide, for example, potassium carbonate, sodium carbonate, lithium carbonate, potassium hydroxide, sodium hydroxide, lithium hydroxide, or any combination thereof. For example, in some embodiments, the base includes potassium carbonate. In some embodiments, the organic base includes N,N-diisopropylethylamine, trimethylamine, or any combination thereof.

### Reaction Conditions

In some embodiments, the compound of Formula (I) and the compound of Formula (II) are contacted in a reaction mixture including the base and a solvent. The solvent can include any solvent in which a compound of Formula (I) of the present disclosure, a compound of Formula (II) of the present disclosure, and a base of the present disclosure are sufficiently soluble to react. In some embodiments, the solvent includes an organic solvent. For example, in some embodiments, the solvent includes a polar aprotic solvent. In certain embodiments, the solvent includes a high-boiling solvent (e.g., having a boiling point greater than 100° C. at 1 atm.) In some embodiments, the solvent includes dimethylformamide, dimethyl sulfoxide, n-methyl pyrrolidone, diethylformamide, or any combination thereof. For example, in some embodiments, the solvent includes dimethylsulfoxide. In another example, in some embodiments, the solvent includes dimethylformamide and dimethyl sulfoxide.

In some embodiments, the compound of Formula (I) and the compound of Formula (II) are each independently present in the reaction mixture in an amount of about 1 wt % to about 25 wt % of the reaction mixture. In some embodiments, the compound of Formula (I) is present in the reaction mixture in an amount of about 1 wt % to about 25 wt %, for example, about 1 wt % to about 20 wt %, about 1 wt % to about 15 wt %, about 2.5 wt % to about 25 wt %, about 2.5 wt % to about 20 wt %, about 2.5 wt % to about 15 wt %, about 5 wt % to about 25 wt %, about 5 wt % to about 20 wt %, or about 1 wt %, about 2 wt %, about 3 wt %, about 4 wt %, about 5 wt % to about 15 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. In some embodiments, the compound of Formula (II) is present in the reaction mixture in an amount of about 1 wt % to about 25 wt % of the reaction mixture, for example, about 1 wt % to about 20 wt %, about 1 wt % to about 15 wt %, about 2.5 wt % to about 25 wt %, about 2.5 wt % to about 20 wt %, about 2.5 wt % to about 15 wt %, about 5 wt % to about 25 wt %, about 5 wt % to about 20 wt %, or about 1 wt %, about 2 wt %, about 3 wt %, about 4 wt %, about 5 wt % to about 15 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

In some embodiments, a molar ratio of the compound of Formula (I) and the compound of Formula (II) present in the reaction mixture is about 1:1.5 to about 1:2.5, for example, about 1:1.5 to about 1:2.25, about 1:1.75 to about 1:2.5, about 1:1.75 to about 1:2.25, or about 1:1.5, about 1:1.75, about 1:2, about 1:2.25, or about 1:2.5.

The reaction mixture can include any amount of base suitable to catalyze a double aromatic nucleophilic substitution reaction between a compound of Formula (I) of the present disclosure and a compound of Formula (II) of the present disclosure. In some embodiments, the base is a base such as described in the present disclosure. In some embodiments, a molar ratio of the compound of Formula (I) and the base present in the reaction mixture present in the reaction mixture is about 1:1 to about 1:10, for example, about 1:1 to about 1:8, about 1:1 to about 1:6, about 1:2 to about 1:10, about 1:2 to about 1:8, about 1:2 to about 1:6, about 1:4 to about 1:10, about 1:4 to about 1:8, about 1:4 to about 1:6, or about 1:1, about 1:2, about 1:3, about 1:4, about 1:5, about 1:6, about 1:7, about 1:8, about 1:9, or about 1:10.

In some embodiments, a temperature of the reaction mixture is about 20° C. to about 140° C., for example, about 20° C. to about 120° C., about 20° C. to about 90° C., about 35° C. to about 140° C., about 35° C. to about 120° C., about 35° C. to about 90° C., about 50° C. to about 140° C., about 50° C. to about 120° C., about 50° C. to about 90° C., or about 40° C., about 50° C., about 60° C., about 70° C., about 80° C., about 90° C., about 100° C., or about 110° C.

The reaction mixture can be formed, for example, by adding each of the compound of Formula (I), the compound of Formula (II), and the base to the solvent simultaneously or in series, each independently in one or more portions. In some embodiments, the reaction mixture is formed by heating the solvent, then adding a first portion of the base, then adding a first portion of the compound of Formula (I), and then adding a second portion of the base and a second portion of the compound of Formula (II). In some embodiments, the reaction mixture is formed by heating a first portion of the solvent, then adding the compound of Formula (I), a first portion of the base, and the compound of Formula (II) to the first portion of the solvent, then adding a second portion of the solvent, and then adding a second portion of the base.

In some embodiments, the method includes contacting the compound of Formula (I) and the compound of Formula (II) (for example, in a reaction mixture of the present disclosure) for a total amount of time of about 1 hour to about 14 days, for example, about 1 hour to about 7 days, about 1 hour to about 3 days, about 18 hours to about 14 days, about 18 hours to about 7 days, about 18 hours to about 3 days, about 1.5 days to about 14 days, about 1.5 days to about 7 days, about 1.5 days to about 3 days, or about 6 hours, about 12 hours, about 18 hours, about 1 day, about 1.5 days, about 2 days, about 3 days, about 4 days, about 5 days, about 6 days, about 7 days, about 10 days, or about 14 days.

### Poly(Crown Ether)s

Also provided in the present disclosure are poly(crown ether)s prepared according to a method of the present disclosure. For example, in some embodiments, the poly(crown ether) contains a structural repeat unit of Formula (III):

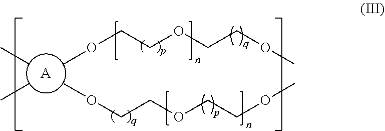

wherein A, n, p, and q are as defined in the present disclosure.

In some embodiments of Formula (III), A is:

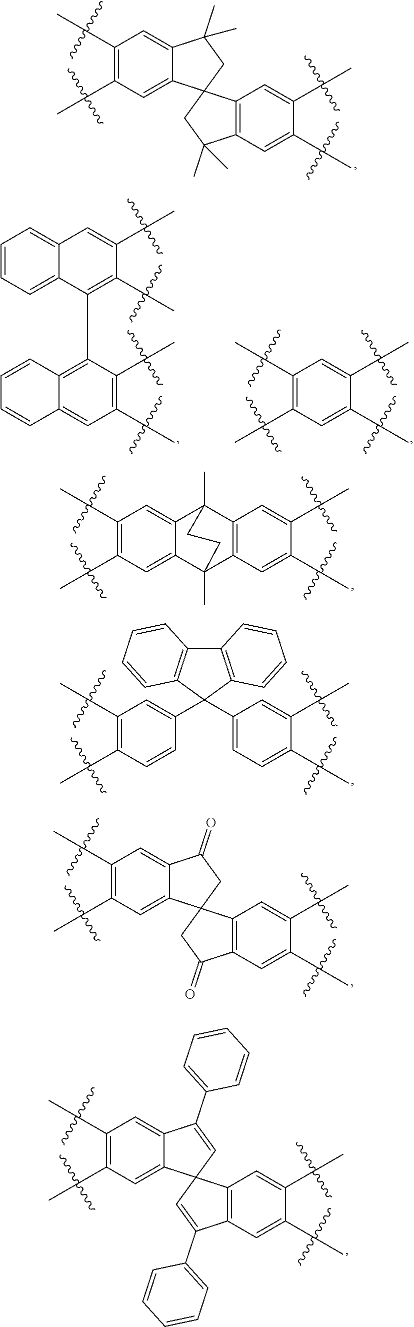

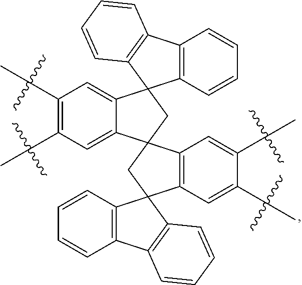 [SMILES: *c1cc2c(cc1*)C1(CC23CC2(c4ccccc4-c4ccccc42)c2cc(*)c(*)cc23)c2ccccc2-c2ccccc21]

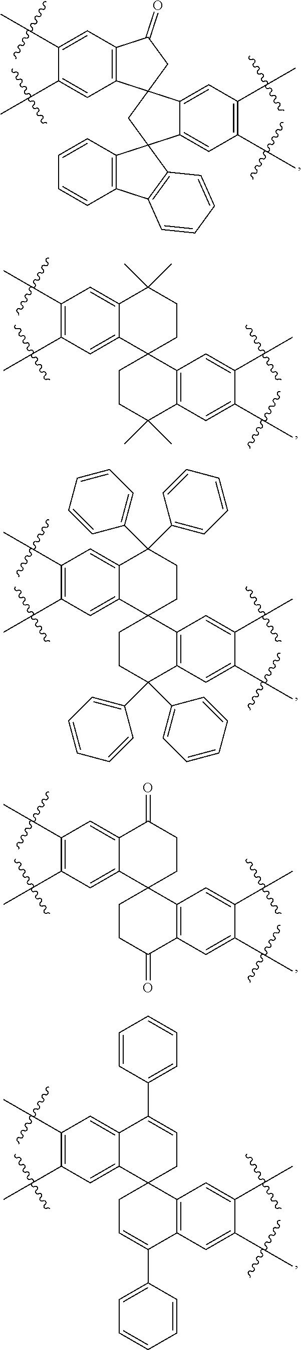

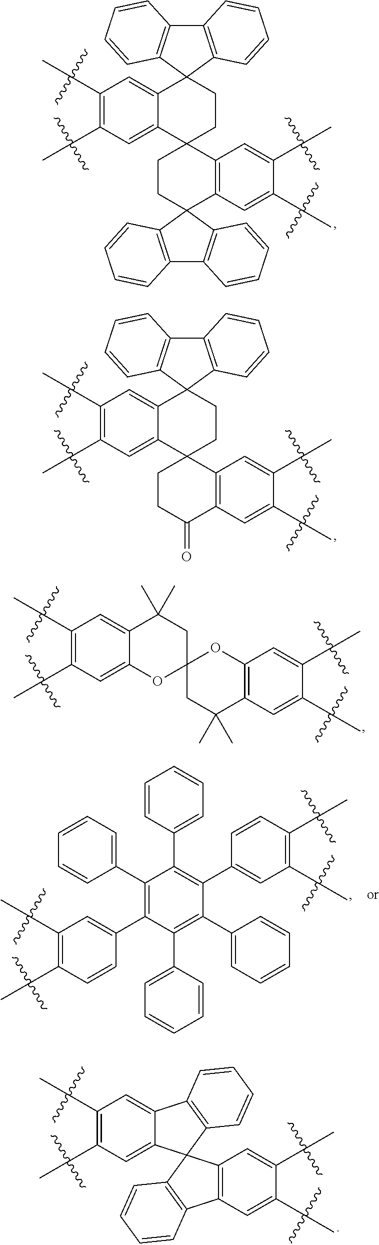

Also provided in the present disclosure are membranes including a poly(crown ether) including a structural repeat unit of Formula (III) (e.g., a poly(crown ether) prepared according to a method of the present disclosure). Such membranes can be used for industrial gas processing applications including, for example, natural gas liquid recovery, CO₂ separation, acid gas separation, sour gas separation, and the like. Other applications for membranes of the present disclosure include metal-ion capture (e.g., in a wastewater treatment process), and proton exchange (e.g., in a fuel cell).

### EXAMPLES

Poly(crown ether)s were directly synthesized from commercially available chemicals. 5,5′,6,6′-tetrahydroxyl-3,3,3′,3′-tetramethyl-1,10-spirobisindane, bis(chloroethyl) ether, potassium carbonate, dimethyl formamide, dimethyl sulfoxide, methanol, and tetrahydrofuran were received from the Millipore Sigma, USA and were used as received without further purification. Examples 1 and 2, below, provided structurally similar polymeric networks via two different synthetic routes.

### Example 1 - Poly(Crown Ether) A (PolyCE A)

### Synthesis

K₂CO₃ (8.12 g) in 100 mL of dimethyl sulfoxide (DMSO) was heated to 105° C. in an oil bath to dissolve the maximum amount of K₂CO₃ and then cooled to 70° C. 5,5′,6,6′-tetrahydroxyl-3,3,3′,3′-tetramethyl-1,10-spirobisindane (spiro) (10 g, 0.02937 mol) was added to the reaction flask. After stirring for 1 h, half of the bis(chloroethyl) ether (3.45 mL) was added using a micropipette and stirred at 70° C. for 5 days under nitrogen. Then, a second portion of K₂CO₃ (8.12 g) and the other half of the bis(chloroethyl) ether (3.45 mL) were added, and the reaction mixture was stirred for 30 h at 70° C. The reaction mixture was cooled to room temperature and the formed gel was dispersed in cold acidic water solution (44 mL HCl and 500 mL water) in a beaker. The gel was crushed with a spatula and stirred for 2 hours, then light-brown colored precipitates were collected by centrifuge. Solids were washed with water (3×). Next, the washed solid was heated in tetrahydrofuran and precipitated using methanol. The precipitates were washed with methanol and the product was dried in a vacuum oven at 80° C. to provide PolyCE A.

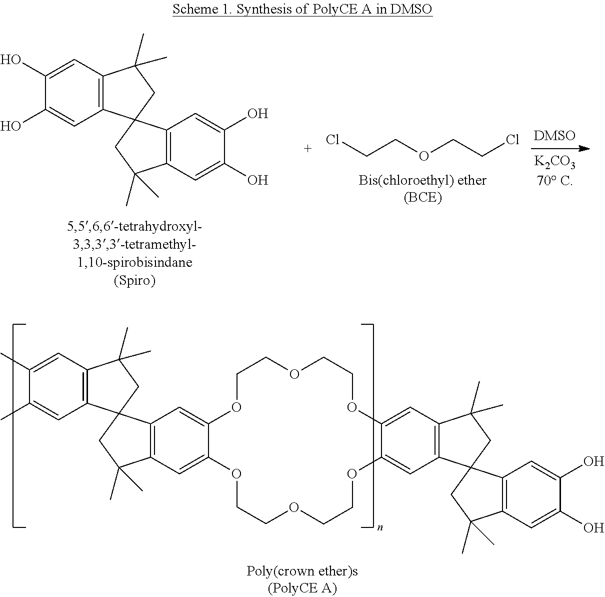

### Characterization

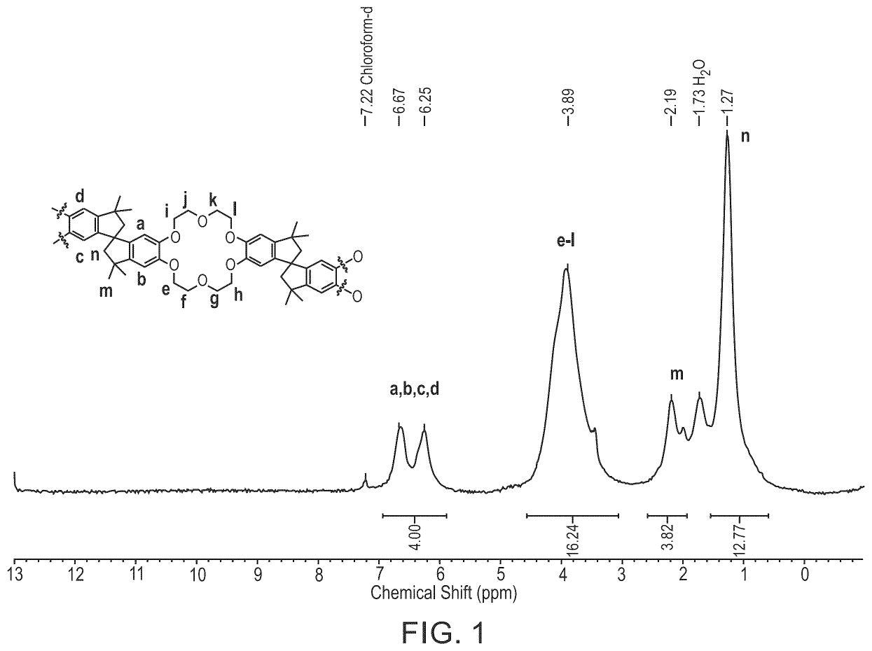

NMR spectra (FIG. 1) were recorded in deuterated chloroform (CDCl₃) using Nanalysis Benchtop NMR spectrometer (60 MHz). The chemical shifts for PolyCE A showed the formation of the desired product, and the respective peaks are assigned in FIG. 1. ¹H NMR (60 MHz, Chloroform-d): δ6.92-5.88 (m, 4H), 4.56-3.06 (m, 16H), 2.19(S, 4H), 1.27 (s, 13H).

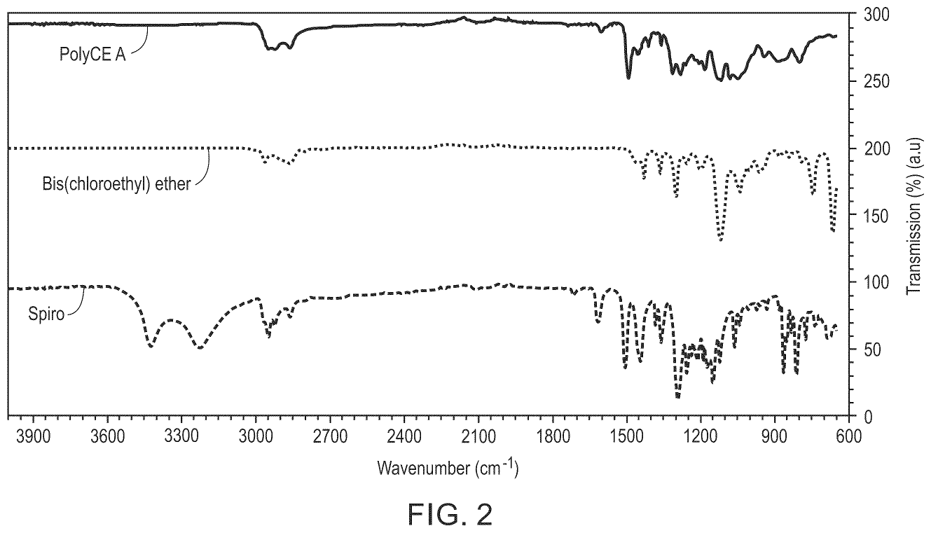

FTIR spectra were recorded for PolyCE A and the respective monomers (spiro and bis(chloroethyl) ether) in the range 600-4000 cm⁻¹ using a Cary 630 FTIR (Agilent) spectrometer. Results are shown in FIG. 2.

As shown in FIG. 2, the FTIR spectrum of PolyCE A did not contain the reactive functional groups' IR stretching bands, such as broad catecholic hydroxy groups between 3000-3600 cm⁻¹ from the spiro monomer or the strong C-Cl stretching band at ca. 610 cm⁻¹ from bis(chloroethyl)ether. This indicated substitution of hydroxy groups to halogenated centers between the monomers after polymerization. PolyCE A showed a stretching band between 1050-1250 (cm⁻¹), indicating the presence of ether (C—O) bonds.

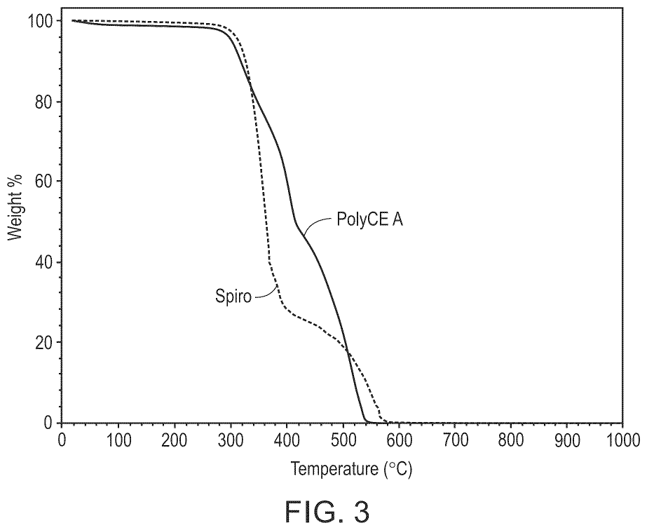

Thermogravimetric analysis (TGA) was conducted for spiro and PolyCE A. TGA of samples were carried out on the SDT q600 TA instrument. The samples were heated to 1000° C. with a 10° C./min heating rate under 100 mL/min air flow. Results are shown in FIG. 3.

Based on extrapolated onset temperatures, the decomposition of 5,5′,6,6′-tetrahydroxy-3,3,3′,3′ tetramethyl-1,1′-spirobisindane monomer (spiro) began at ca. 330° C. and made an inflection to downside approximately at 510° C. PolyCE A showed decomposition at ca. 300° C. and then showed two decomposition inflections at 385° C. and 475° C. Early decomposition of the polymer could be attributed to residual unreacted catechol groups. Slight weight loss in the low-temperature region is due to residual water and organic solvents in the polymer.

Gel Permeation Chromatography was employed to evaluate the weight average molecular weight of PolyCE A. Polystyrene standards were used for calibration. Solutions of PolyCE A in chloroform were used for weight average molecular weight analysis. The weight average molecular weight of the PolyCE A was found to be 443,000 g/mol.

### Example 2 - Poly(Crown Ether) B (PolyCE B)

### Synthesis

5,5′,6,6′ -tetrahydroxyl-3,3,3′,3′-tetramethyl-1,10-spirobisindane (spiro) (1.00 g, 0.002937 mol), K₂CO₃ (0.812 g), and bis(2-chloroethyl) ether (2.86 g, 0.005875 mol) were added to 12 mL anhydrous dimethylformamide (DMF) and stirred at 70° C. for 16 h under nitrogen. Then 12 ml dimethyl sulfoxide (DMSO) was added to the solution and stirred at 70° C. for 1 h. An additional 0.9 g of K₂CO₃ was added and the reaction mixture was stirred at 70° C. for 24 h. Upon completion, the reaction mixture was cooled to room temperature and poured into ice water (300 mL) and HCl (37 wt %, 44 mL) solution. This mixture was stirred for 2 h. Solids were centrifuged and washed with water (3×), then the product was dissolved in THF. The product was precipitated using methanol, the precipitates were washed with methanol (3×) and then dried at 80° C. in a vacuum oven to provide PolyCE B.

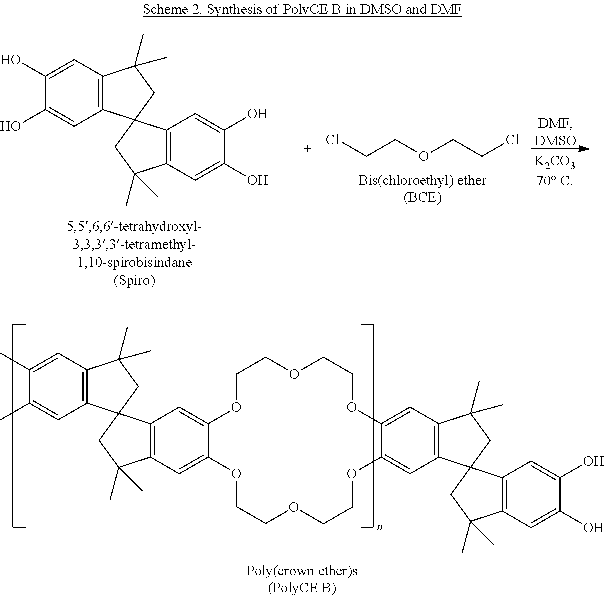

### Characterization

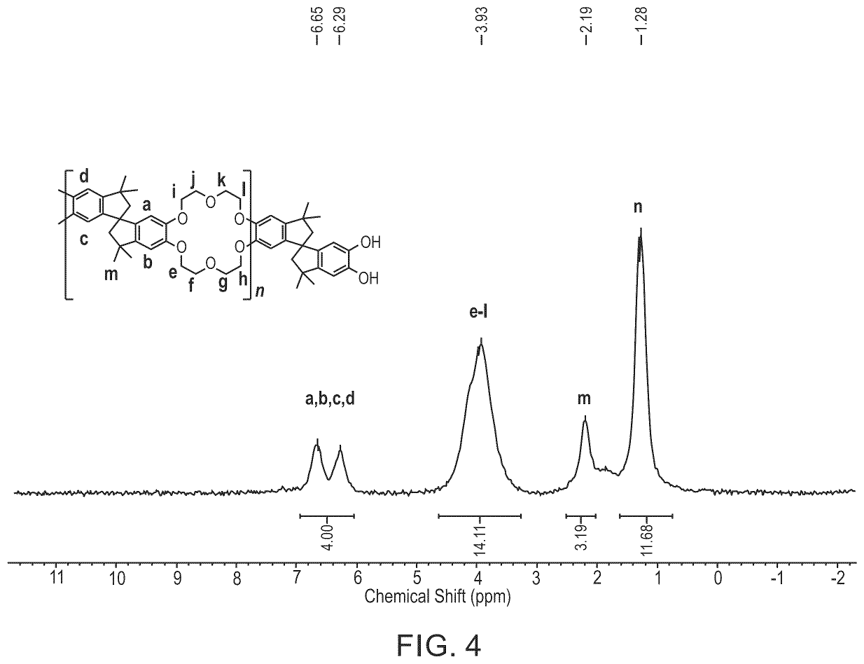

NMR spectra (FIG. 4) were recorded in deuterated chloroform (CDCl₃) using Nanalysis Benchtop NMR spectrometer (60 MHz). Samples were heated to 35° C. prior to analysis. The chemical shifts for PolyCE B showed the formation of the desired product, and the respective peaks are assigned in FIG. 4. ¹H NMR (60 MHz, Chloroform-d): δ6.47(d, J=21.3 Hz, 1 H), 4.46-3.57 (m, 1 H), 2.19 (s, 4H), 1.28 (s, 3H).

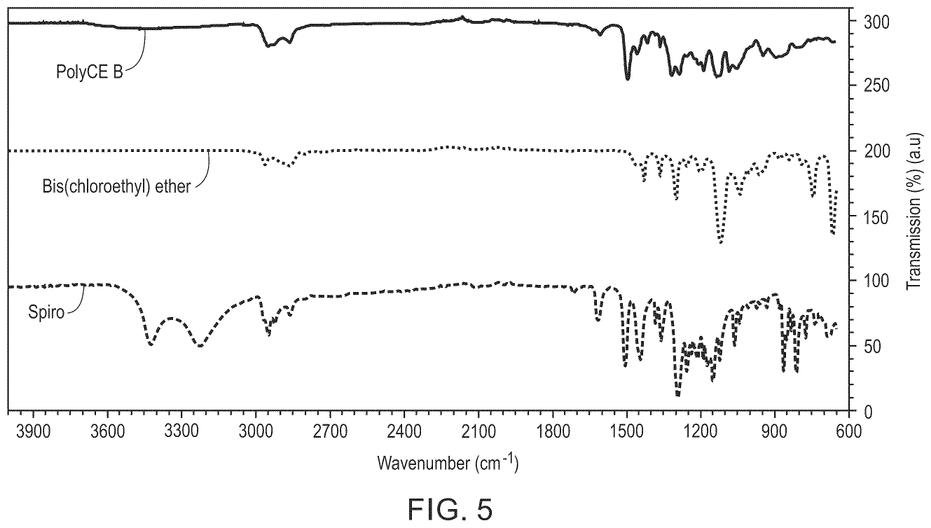

FTIR spectra were recorded for PolyCE B and the respective monomers (spiro and bis(chloroethyl) ether) in the range 600-4000 cm⁻¹ using a Cary 630 FTIR (Agilent) spectrometer. Results are shown in FIG. 5.

As shown in in FIG. 5, the FTIR spectrum of PolyCE B did not contain reactive functional groups' IR stretching bands such as broad catecholic hydroxy groups between 3000-3600 (cm⁻¹) from spiro monomer or the strong C-Cl stretching band at ca. 610 cm⁻¹ from bis(chloroethyl)ether. This indicated substitution of hydroxy groups to halogenated centers between the monomers after polymerization. PolyCE B showed a stretching band between 1050-1250 (cm⁻¹) manifesting the presence of inherited ether (C—O) bonds.

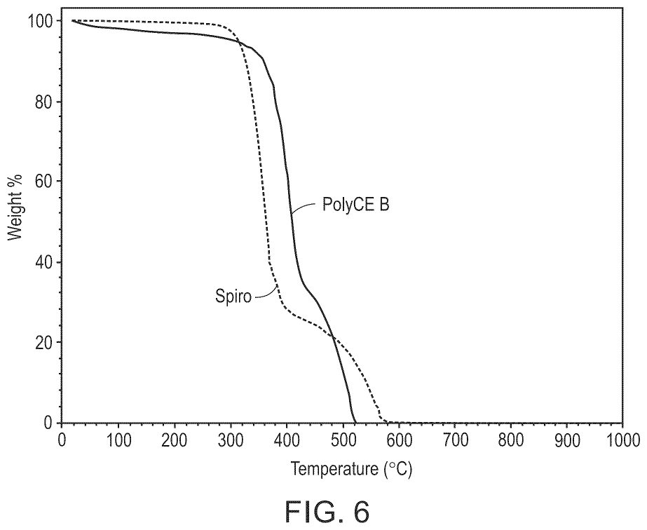

Thermogravimetric analysis (TGA) was conducted for spiro and PolyCE B. TGA of samples were carried out on the SDT q600 TA instrument. The samples were heated to 1000° C. with a 10° C./min heating rate under 100 mL/min air flow. Results are shown in FIG. 6.

The decomposition of 5,5′,6,6′-tetrahydroxy-3,3,3′,3′ tetramethyl-1,1′-spirobisindane monomer (spiro) began at ca. 330° C. and made inflection approximately at 510° C. while PolyCE B showed decomposition temperatures at ca. 370° C. and then ca. 445° C. based on extrapolated onset temperatures. Additionally, PolyCE B showed weight loss at below 60° C., which corresponded to residual organic solvents in the polymer pores, as well as water desorption at above 100° C. Residual solvent formed less than 2% of total weight.

Gel Permeation Chromatography was employed to evaluate the weight average molecular weight of PolyCE B. Polystyrene standards were used for calibration. Solutions of PolyCE B in chloroform were used for weight average molecular weight analysis. The weight average molecular weight of PolyCE B was found to be 217,000 g/mol. The higher molecular weight for PolyCE A (see Example 1) relative to PolyCE B was due to the longer reaction time and step-wise addition of linker during the polymerization reaction.

### Example 3-Poly(Crown Ether) Films

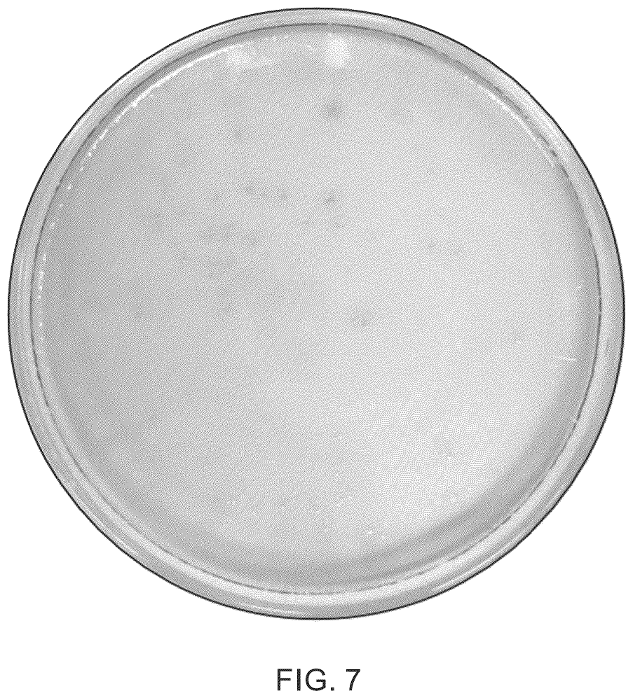

PolyCE A was found to be soluble in chloroform, which allowed for film formation (FIG. 7). The processability of the poly(crown ether) can extend the application of such polymers to membranes for gas separation, metal ion capture, fuel cells, etc.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of preparing a poly(crown ether), the method comprising:
contacting a compound of Formula (I): 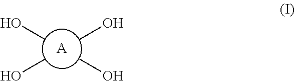
with a compound of Formula (II): 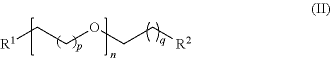
in the presence of a base;
wherein:
A is C₆-C₄₀ aryl or C₄-C₃₈ heteroaryl, each optionally substituted with 1-8 R^{a};
each R^{a} is independently selected from oxo, cyano, C₆-C₁₄ aryl, C₁-C₄ alkyl, and C₁-C₄ alkoxy;
R¹ and R² are each independently halo;
p and q are each independently 1-4; and
n is 0-8.

2. The method of claim 1, wherein each —OH is attached to a carbon ring member of an all-carbon aromatic ring.

3. The method of claim 2, wherein each carbon ring member attached to an —OH is further attached to one other carbon ring member attached to an —OH.

4. The method of claim 1, wherein A is C₆-C₂₀ aryl.

5. The method of claim 4, wherein A is C₆-C₁₄ aryl optionally substituted with 1-6 R^{a}, and wherein each R^{a} is independently C₆-C₁₄ aryl.

6. The method of claim 1, wherein A is C₁₀-C₄₀ aryl.

7. The method of claim 1, wherein A comprises a multiple-condensed ring system.

8. The method of claim 7, wherein A comprises an all-carbon multiple-condensed ring system.

9. The method of claim 7, wherein the multiple-condensed ring system comprises two or more spiro-linked rings.

10. The method of claim 7, wherein the multiple-condensed ring system comprises two or more bridged rings.

11. The method of claim 7, wherein the multiple-condensed ring system is substituted with 1-4 R^{a}, and wherein each R^{a} is independently selected from oxo, C₆-C₁₄ aryl, and C₁-C₄ alkyl.

12. The method of claim 7, wherein the multiple-condensed ring system comprises one or more rings derived from fluorene, indane, indene, chromane, naphthalene, or any combination thereof.

13. The method of claim 12, wherein the multiple-condensed ring system comprises two or more spiro-linked rings derived from fluorene, indane, indene, or any combination thereof.

14. The method of claim 1, wherein the compound of Formula (I) is

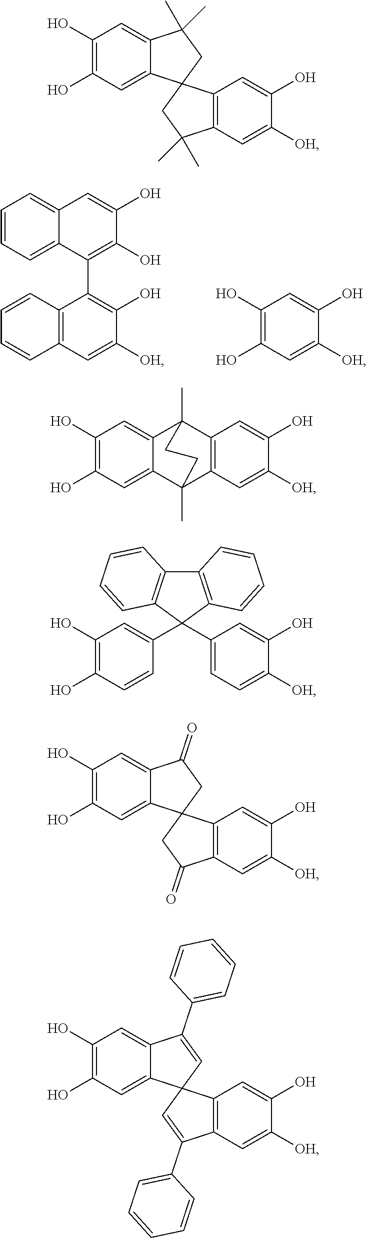

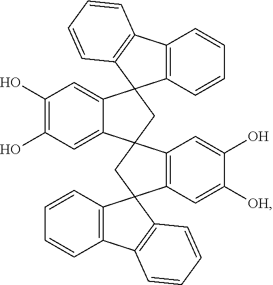 [SMILES: Oc1cc2c(cc1O)C1(CC23CC2(c4ccccc4-c4ccccc42)c2cc(O)c(O)cc23)c2ccccc2-c2ccccc21]

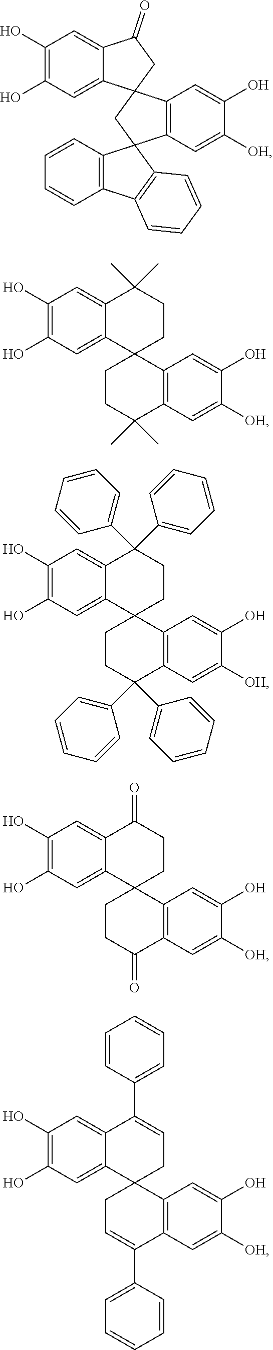

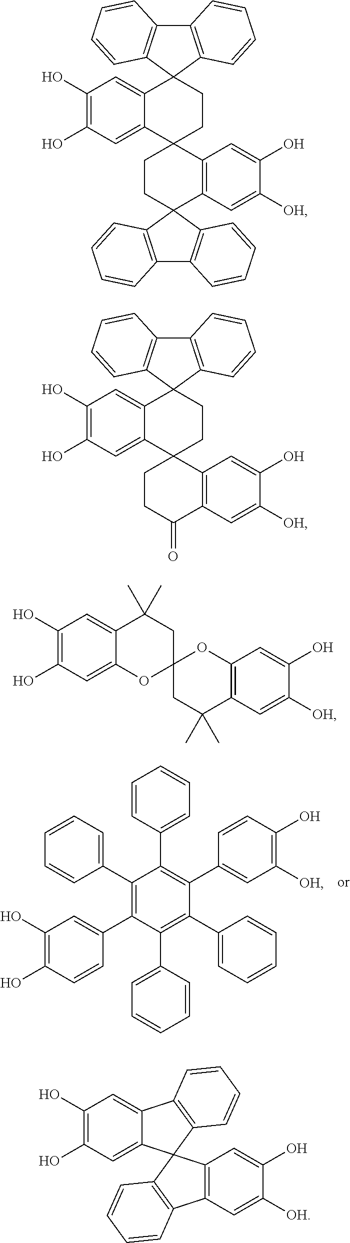

15. The method of claim 1, wherein p and q are each 1.

16. The method of claim 1, wherein p and q are each 2.

17. The method of claim 16, wherein n is 0.

18. The method of claim 16, wherein n is 1-4.

19. The method of claim 1, wherein R¹ and R² are the same.

20. The method of claim 1, wherein R¹ and R² are each independently —F or —Cl.

21. The method of claim 1, wherein the base comprises an inorganic base, an organic base, or any combination thereof.

22. The method of claim 21, wherein the inorganic base comprises potassium carbonate, sodium carbonate, lithium carbonate, potassium hydroxide, sodium hydroxide, lithium hydroxide, or any combination thereof.

23. The method of claim 21, wherein the organic base comprises N,N-diisopropylethylamine, trimethylamine, or any combination thereof.

24. The method of claim 1, wherein the compound of Formula (I) and the compound of Formula (II) are contacted in a reaction mixture comprising the base and a solvent.

25. The method of claim 24, wherein the solvent comprises dimethylformamide, dimethyl sulfoxide, n-methyl pyrrolidone, diethylformamide, or any combination thereof

26. The method of claim 24, wherein the compound of Formula (I) and the compound of Formula (II) are each independently present in the reaction mixture in an amount of about 1 wt % to about 25 wt % of the reaction mixture.

27. The method of claim 24, wherein a molar ratio of the compound of Formula (I) and the compound of Formula (II) present in the reaction mixture is about 1:1.5 to about 1:2.5.

28. The method of claim 24, wherein a molar ratio of the compound of Formula (I) and the base present in the reaction mixture is about 1:1 to about 1:10.

29. The method of claim 24, wherein a temperature of the reaction mixture is about 20° C. to about 140° C.

30. The method of claim 24, comprising contacting the compound of Formula (I) and the compound of Formula (II) for about 1 hour to about 14 days.

31. A poly(crown ether), prepared according to the method of claim 1.

32. A poly(crown ether) comprising a structural repeat unit of Formula (III): 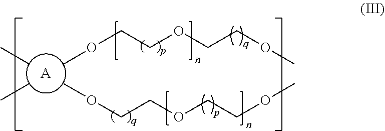
wherein:
A is C₆-C₄₀ aryl or C₄-C₃₈ heteroaryl, each optionally substituted with 1-8 R^{a};
each R^{a} is independently selected from oxo, cyano, C₆-C₁₄ aryl, C₁-C₄ alkyl, and C₁-C₄ alkoxy;
p and q are each independently 1-4; and
n is 0-8.
